(19) United States
(12) Patent Application Publication
(10) Pub. No.: US 2023/0398635 A1
(43) Pub. Date: Dec. 14, 2023

(54) SLOTTED COATINGS AND METHODS OF FORMING THE SAME

(71) Applicant: General Electric Company, Schenectady, NY (US)

(72) Inventors: Hrishikesh Keshavan, Bengaluru (IN); Bernard P. Bewlay, Niskayuna, NY (US); Byron A. Pritchard, Loveland, OH (US); Curtis A. Johnson, Schenectady, NY (US); Hongqiang Chen, Niskayuna, NY (US); Jared Micheal Iverson, Amalga, UT (US); Weston B. Griffin, Niskayuna, NY (US); Younkoo Jeong, Clifton Park, NY (US); Jaewon Moon, Flushing, NY (US)

(21) Appl. No.: 17/806,608

(22) Filed: Jun. 13, 2022

(51) Int. Cl. B23K 26/364; B23K 26/046; B23K 26/08; B23K 26/082; B23K 26/70; B23K 26/03

(52) U.S. Cl. CPC B23K 26/364; B23K 26/046; B23K 26/0823; B23K 26/082; B23K 26/70; B23K 26/032; B23K 2101/34

(57) ABSTRACT

A coated part, such as a ceramic coated part, having a slot formed in a coating formed on a curvilinear portion of the part and a method of forming the slot. The method includes performing a plurality of laser ablation passes. Each laser ablation pass includes focusing a laser beam to a focus depth, irradiating the coating of the curvilinear portion with the laser beam focused at the focus depth to remove coating material of the coating by laser ablation, and scanning the laser beam in a scanning direction while irradiating the coating of the curvilinear portion with the laser beam. The scanning direction is a direction transverse to a thickness direction of the coating. The focus depth of each subsequent pass of the plurality of laser ablation passes is deeper in a thickness direction of the coating than the pass preceding the subsequent pass.

### TECHNICAL FIELD

The present disclosure relates to slotted coatings, particularly, ceramic coatings on components for aircraft gas turbine engines. The present disclosure also relates to methods of forming the slotted coatings.

### BACKGROUND

Thermal barrier coatings (TBCs) are used as a coating for components in gas turbine engines. In many applications, a metal substrate is coated with the TBC. The TBC may be a ceramic insulating material that reduces the service temperature of the underlying metallic segments of the components.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 shows a component that may be coated with a ceramic coating according to an embodiment of the present disclosure.

FIG. 2 is a detail view, showing detail 2 in FIG. 1, of a flange of the component shown in FIG. 1.

FIG. 3 is a view of the flange of the component shown in FIG. 1, looking towards the edge (a curvilinear portion) of the flange.

FIG. 4 is another view of a flange of the component shown in FIG. 1 from a view that is elevated from the view shown in FIG. 3 to look more towards a planar portion of the flange.

FIG. 5 shows a flange of a component coated with a ceramic coating according to another embodiment of the present disclosure.

FIG. 6 is a cross-sectional view, taken along line 6-6 in FIG. 2, of the component and ceramic coating shown in FIG. 1.

FIG. 7 shows a laser system that may be used to form slots in the ceramic coating of the component shown in FIG. 1.

FIG. 8 is a cross-sectional view, taken along line 8-8 in FIG. 2, of the component and ceramic coating shown in FIG. 1, illustrating a method of forming the slots at a step prior to the formation of the slots.

FIGS. 9A to 9D are cross-sectional views similar to FIG. 6 taken at different times as the slot is being formed. FIG. 9A is a portion of the component and ceramic coating taken after a first laser ablation pass. FIG. 9B is the portion of the component and ceramic coating shown in FIG. 9A taken after a second laser ablation pass. FIG. 9C is the portion of the component and ceramic coating shown in FIG. 9A taken after a third laser ablation pass. FIG. 9D is the portion of the component and ceramic coating shown in FIG. 9A taken after a fourth laser ablation pass.

FIG. 10 shows a calibration assembly that may be used with a calibration method according to an embodiment of the present disclosure.

FIG. 11 is a detail view, showing detail 11 in FIG. 10, of a flange of the calibration assembly shown in FIG. 10.

FIG. 12 shows a field of view of a first camera in the laser system shown in FIG. 7 during steps of the calibration method.

FIG. 13 shows the field of view of the first camera during steps subsequent to the steps of the calibration method illustrated in FIG. 12.

FIG. 14 shows a field of view of a second camera in the laser system shown in FIG. 7 during steps subsequent to the steps of the calibration method illustrated in FIG. 13.

### DETAILED DESCRIPTION

Features, advantages, and embodiments of the present disclosure are set forth or apparent from a consideration of the following detailed description, drawings, and claims. Moreover, the following detailed descriptions are exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” “third,” and the like may be used interchangeably to distinguish one component from another and are not intended to signify location or importance of the individual components.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or the machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

In the present disclosure, when a layer is being described as “on” or “over” another layer or substrate, the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

As noted above, ceramic thermal barrier coatings (TBCs) may be used to insulate an underlying substrate, such as a component made from a metal alloy. These ceramic TBCs preferably may be used in gas turbine engines on components that are exposed to hot combustion gases of the engine. The differential thermal expansion of the ceramic coating and the underlying metallic substrate may result in cracks forming in the TBC from the thermal cycling of the gas turbine engine during normal operation. This cracking may lead to spallation of the TBC. To mitigate this spallation issue, slots may be formed in the TBC to provide strain relief or strain tolerance.

Environmental dust, such as dust containing some combination of calcium-magnesium-alumino-silicate (CMAS), is often ingested into the hot sections of gas turbine engines. The dust can deposit on components in the engine and, due to the high surrounding temperatures, can become molten. If the TBC includes engineered pores and/or columns for strain tolerance, the resulting low-viscosity liquid (molten/liquid CMAS) may infiltrate into the engineered pores and/or columns of the TBC on the component. Once the liquid CMAS solidifies upon cooling, the compliance of the TBC and the strain tolerance capability of the coating decreases dramatically. Engineered slots formed by processes such as plasma spray (APS) methods and the use of columnar TBCs produced by electron beam physical vapor deposition (EBPVD) methods, for example, may be particularly susceptible to such issues.

A laser ablation process may be used to form slots in the TBC. Slots formed by the laser ablation process can be made wide enough to prevent contaminants from filling the slot and removing the strain tolerance provided by the slot, and, thus, slots formed in this way are less susceptible to the CMAS issues discussed above. Conventional laser ablation processes, however, can be used on flat (planar) portions of components, leaving non-planar (e.g., curved) portions of the component unslotted and susceptible to the thermal strain issues discussed above. Consequently, such non-planar surfaces may be susceptible to spallation of the TBC. Components of gas turbine engines that are coated with the TBC, such as components of the combustor and/or turbine, often have non-planar (curved) portions. This disclosure discusses a laser ablation process that can be used to from engineered slots in coatings on non-planar and curvilinear portions of components. As this laser ablation process is performed in three-directional (3D) space, a calibration process is also discussed herein to facilitate forming engineered slots on the curvilinear portions of components. The resulting components have a ceramic coating that provides good coating durability and balances thermal strain tolerance, environmental resistance (particularly to CMAS), and heat transfer performance on the curvilinear portions of components.

As noted above, the ceramic coating and processes discussed herein are particularly suitable for use on coatings of components that are used in gas turbine engines, such as gas turbine engines of an aircraft, an industrial gas turbine engine incorporated into a power generation system, a nautical gas turbine engine, and the like. Such gas turbine engines may include a turbomachine having an outer casing (also referred to as a housing or a nacelle) that encases an engine core. The engine core includes, in a serial flow relationship, a compressor section including a booster or a low-pressure (LP) compressor and a high-pressure (HP) compressor, a combustion section, a turbine section including a high-pressure (HP) turbine and a low-pressure (LP) turbine, and a jet exhaust nozzle section. The outer casing may also define an inlet. The compressor section, the combustion section, and the turbine section together define, at least in part, a core air flow path extending from the inlet to the jet exhaust nozzle section. The combustion section may include a combustor, such as an annular combustor, that includes a plurality of fuel nozzles that inject fuel into a combustion chamber defined between an inner combustion liner and an outer combustion liner. Air flowing through the core air flow path is mixed with the fuel in the combustion chamber and combusted forming combustion products (combustion gases).

The combustion gases are discharged from the combustion chamber and flow into the turbine section. The turbine section may include a plurality of turbine rotors that comprise, for example, a disk and a plurality of turbine blades extending from the disk. The turbine section may also include a plurality of nozzles that direct the combustion gases into the turbine blades to rotate the turbine rotors.

A ceramic TBC may be applied to the surfaces of these components that are exposed to the high temperature combustion gases, including, for example, portions of the combustion section and the turbine section. The TBC may be applied to the combustor liners, portions of the fuel nozzle, such as an aft heat shield, the turbine nozzles, and the turbine blades of the turbine rotors. The following discussion uses the aft heat shield as an example of such components to which the ceramic coating (e.g., the TBC coating) and methods discussed herein may be applied. The ceramic coatings and the methods discussed herein, however, are also applicable to other ceramic coatings, particularly TBC coatings, on other components, such as the other gas turbine engine components.

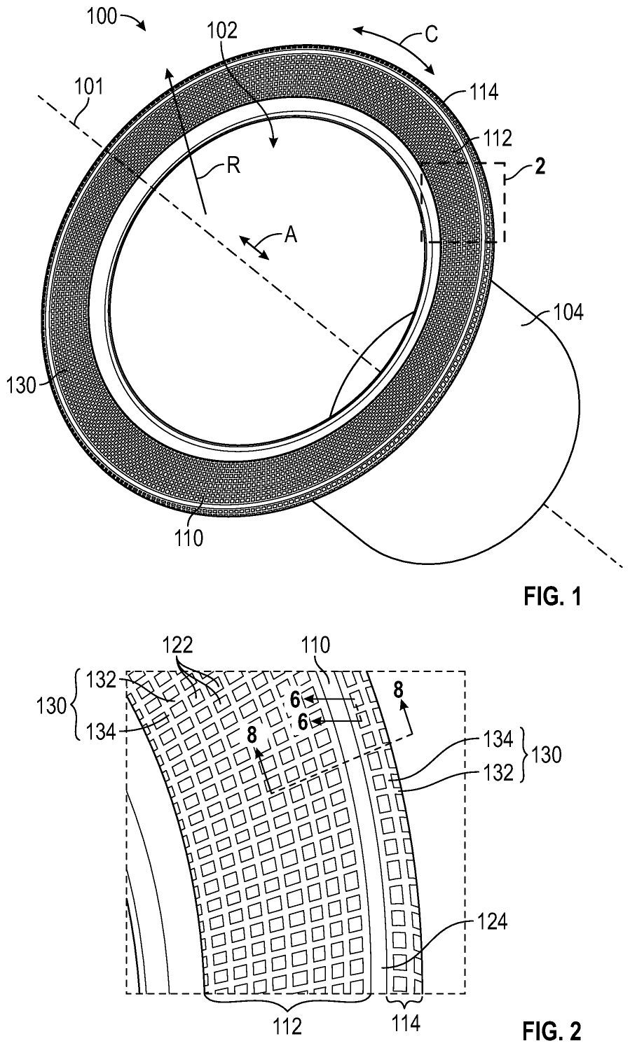

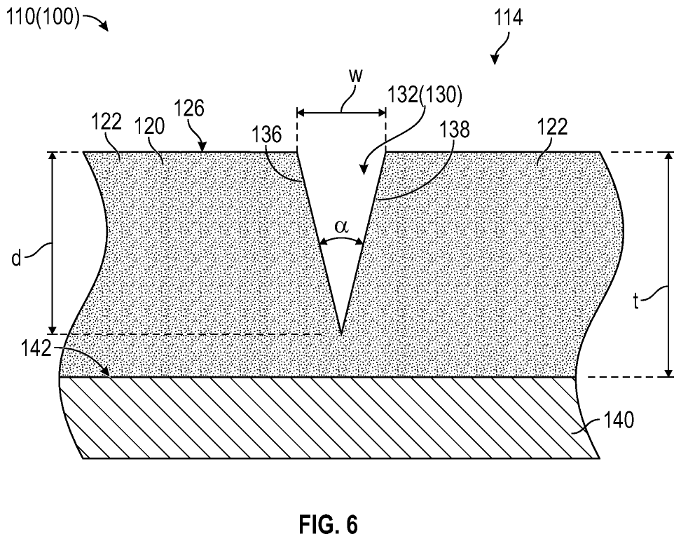

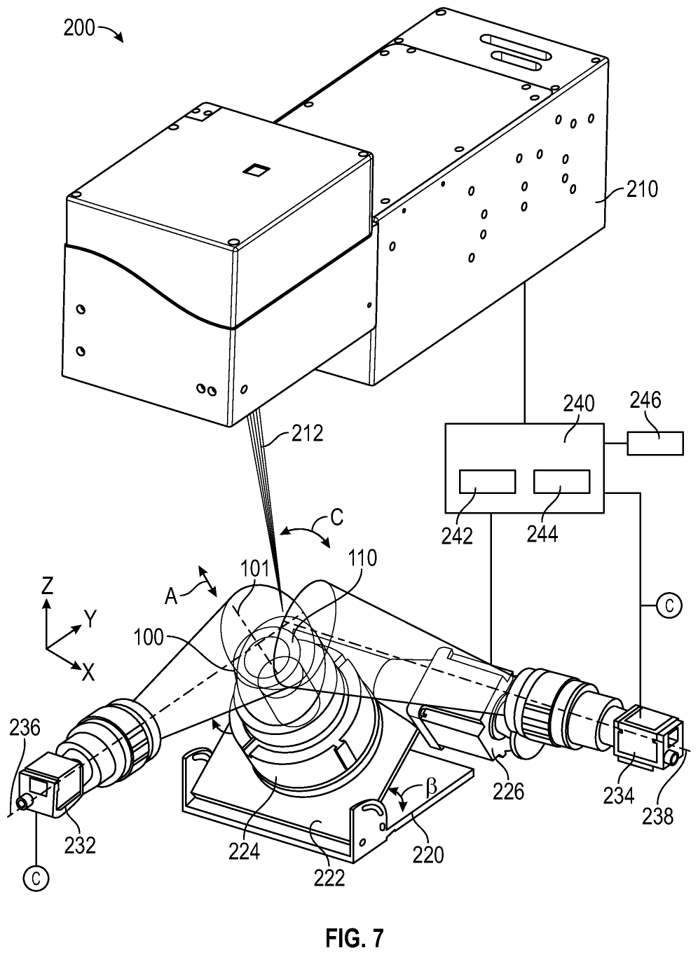

FIG. 1 shows a fuel nozzle aft heat shield (a component) 100 that may be coated with a ceramic coating 120 (FIG. 6) having a plurality of engineered slots 130 formed therein using the methods discussed below. The aft heat shield 100 of this embodiment is cylindrical having an axial direction A, a radial direction R, and a circumferential direction C. The aft heat shield 100 includes a longitudinal (or axial) centerline 101 and the axial direction A is a direction parallel to the longitudinal centerline 101 in this embodiment. The aft heat shield 100 is also annular having a central bore 102. The aft heat shield 100 of this embodiment includes a body 104 and a flange 110. The flange 110 includes a planar portion 112 and a curvilinear portion 114. The curvilinear portion 114 is the outer edge of the flange 110 in this embodiment. This geometry can also be seen in FIG. 7.

FIG. 2 is a detail view, showing detail 2 in FIG. 1, of the aft heat shield 100. The flange 110 is coated with the ceramic coating 120 (FIG. 6) and a plurality of engineered slots 130 (also referred to as slots 130) are formed therein. The slots 130 include a plurality of radial slots 132 and a plurality of circumferential slots 134 formed on the planar portion 112. The radial slots 132 and the circumferential slots 134 are formed in a grid pattern to define a plurality of coating segments 122 between the radial slots 132 and the circumferential slots 134. The radial slots 132 and the circumferential slots 134 are arranged transversely to each other. Although described as being a grid pattern with radial and circumferential slots, other suitable arrangements of slots may be used. A plurality of slots 130 are also formed on the curvilinear portion 114 of the flange 110 using the methods discussed below. Like the planar portion 112, the slots 130 formed in the ceramic coating 120 on the curvilinear portion 114 include a plurality of radial slots 132 and at least one circumferential slot 134. The curvilinear portion 114 includes two circumferential slots 134 in this embodiment.

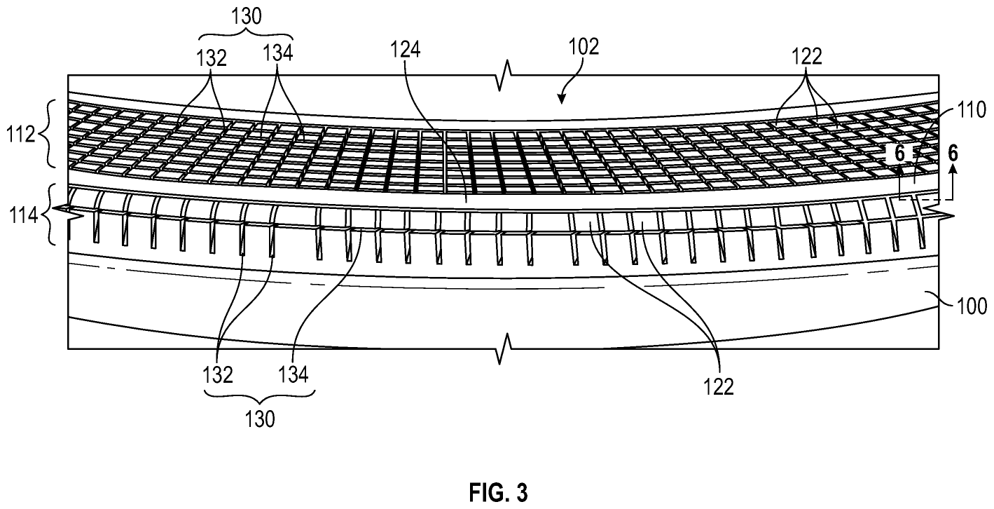

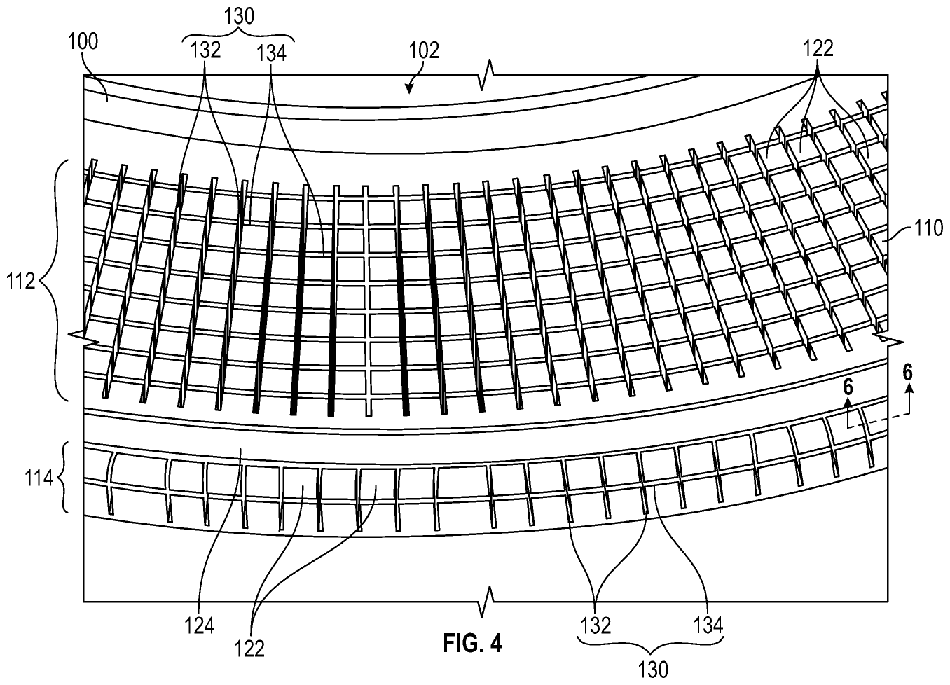

FIGS. 3 and 4 are additional views of the surface of the flange 110 illustrating the slots 130 formed in the ceramic coating 120 (FIG. 6). FIG. 3 is a view of the flange 110 looking towards the edge (curvilinear portion 114) of the flange 110, and FIG. 4 is a view of the flange 110 elevated from the view shown in FIG. 3 to look more towards the planar portion 112 of the flange 110. In some embodiments, the ceramic coating 120 (FIG. 6) on the flange 110 may include a section (referred to herein as a transition section 124) without slots 130 formed therein. This transition section 124 is located in a region between the planar portion 112 and the curvilinear portion 114 of the flange 110, and, in this embodiment, the transition section 124 extends in a circumferential direction of the flange 110. The transition section 124 can also be seen in FIG. 2. In some embodiments, the slots 130 formed in the planar portion 112 may be formed with a different technique than the method discussed herein. The transition section 124 allows one method to be used to form the slots 130 on the curvilinear portion 114, such as where the longitudinal centerline 101 of the aft heat shield 100 is angled relative to a laser beam 212 (see FIG. 7) as discussed further below, and another method to be used to form the slots 130 on the planar portion 112, such as such as where the longitudinal centerline 101 of the aft heat shield 100 is parallel to the laser beam 212.

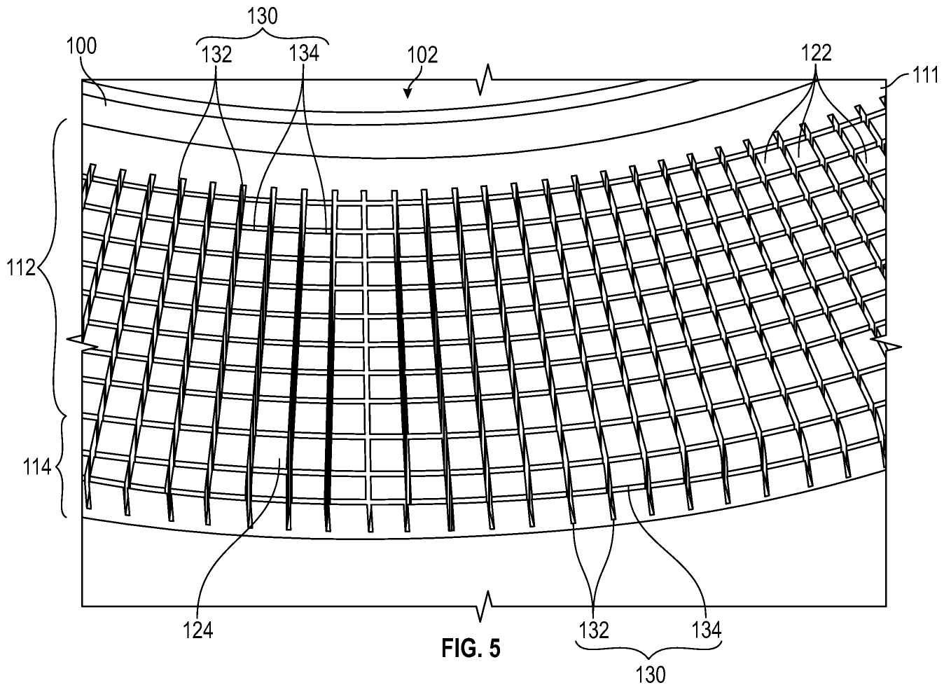

FIG. 5 shows a flange 111 of an aft heat shield according to another embodiment. The flange 111 of this embodiment is the same as the flange 110 discussed above, but the flange 111 of this embodiment does not include a transition section 124. Accordingly, the same reference numerals are be used for features in this embodiment that are the same or similar to the features discussed above. The detailed description of such features above also applies to this embodiment, and that detailed description is omitted here. In this embodiment, the radial slots 132 formed in the curvilinear portion 114 are positioned such that they connect (are continuous) with the radial slots 132 formed in the planar portion 112. The following discussion will reference the aft heat shield 100 and the flange 110 shown in FIGS. 1 to 4, but it is equally applicable to the embodiment shown in FIG. 5.

FIG. 6 is a cross-sectional view of the component (aft heat shield) 100 and, more specifically, the flange 110, taken along line 6-6 in FIG. 2. The section line 6-6 is also shown in FIGS. 3 and 4. The flange 110 of this embodiment is a substrate 140 having a surface 142. The portion of the flange 110 depicted in FIG. 6 is the curvilinear portion 114 and, thus, the surface 142 depicted in FIG. 6 is also a curvilinear portion of the surface 142. The ceramic coating 120 is formed on the substrate 140, and, more specifically, the surface 142 of the substrate 140. In this embodiment, the ceramic coating 120 is formed directly on the surface 142 of the substrate 140. But, in other embodiments, intervening layers may be formed therebetween.

As noted above, the component 100 depicted in this embodiment is an aft heat shield and the ceramic coating 120 is a TBC. Any suitable ceramic may be used as the ceramic of the ceramic coating 120. When the ceramic coating 120 is a TBC, the ceramic of the ceramic coating 120 a may be a stabilized ceramic that can sustain a fairly high temperature gradient such that the coated metallic components can be operated at gas temperatures higher than the melting point of the metal. For instance, the TBC material may be one or more of yttria stabilized zirconia (YSZ) and other rare-earth-stabilized zirconia compositions, mullite (3Al₂O₃-2SiO₂), alumina (Al₂O₃), ceria (CeO₂), rare-earth zirconates (e.g., La₂Zr₂O₇), rare-earth oxides (e.g., La₂O₃, Nb₂O₅, Pr₂O₃, CeO₂), and metal-glass composites, including combinations thereof (e.g., alumina and YSZ or ceria and YSZ). One particularly suitable TBC material is, for example, yttria-stabilized zirconia (YSZ). Besides its high temperature stability, YSZ also has a good combination of high toughness and chemical inertness, and the thermal expansion coefficient of YSZ is a comparatively suitable match to that of the metallic components of the turbine blade being coated. In other embodiments, for example, the ceramic coating 120 may be an environmental barrier coating (EBC) such as used on ceramic matrix composite (CMC) components, and suitable EBC materials include, for example, silicates and aluminosilicates.

As noted above, the substrate 140 may be a metallic substrate formed from a metal suitable for use in a high temperature environment, such as steel or superalloys (e.g., nickel-based superalloys, cobalt-based superalloys, or iron-based superalloys, such as Rene N5, N500, N4, N2, IN718, Hastelloy X, or Haynes 188) or other suitable materials for withstanding high temperatures. The ceramic coating 120 may be disposed along one or more portions of the substrate 140 or disposed substantially over the whole exterior of the substrate 140. The ceramic coating 120 and the substrate 140 are not limited to the particular components and materials of the embodiments discussed herein.

The ceramic coating 120 may be formed by any suitable process. For instance, the ceramic coating 120 may be formed by one or more of the following processes air-plasma spray (APS), electron beam physical vapor deposition (EBPVD), high velocity oxygen fuel (HVOF), electrostatic spray assisted vapor deposition (ESAVD), and direct vapor deposition. The ceramic coating 120 is applied to the surface 142 of the substrate 140 to have a thickness t. Suitable thicknesses include, for example, thicknesses from six hundred ten microns (twenty-four thousandths of an inch) to six hundred sixty microns (twenty-six thousandths of an inch). So that the ceramic coating 120 can provide a thermal and other protective benefit to the substrate 140, the slot 130 preferably does not extend all the way through the thickness t of the ceramic coating 120. The slot 130 has a depth d that is less than the thickness t of the ceramic coating 120. In some embodiments, for example, the ceramic coating 120 has a depth d that is ninety percent or less of the total thickness t of the ceramic coating 120, such as eighty-five percent or less, and eighty percent or less of the total thickness t of the ceramic coating 120. The depth d of the slot 130 also preferably has a depth that is forty percent or more of the total thickness t of the ceramic coating 120, such as fifty percent or more of the total thickness t of the ceramic coating 120.

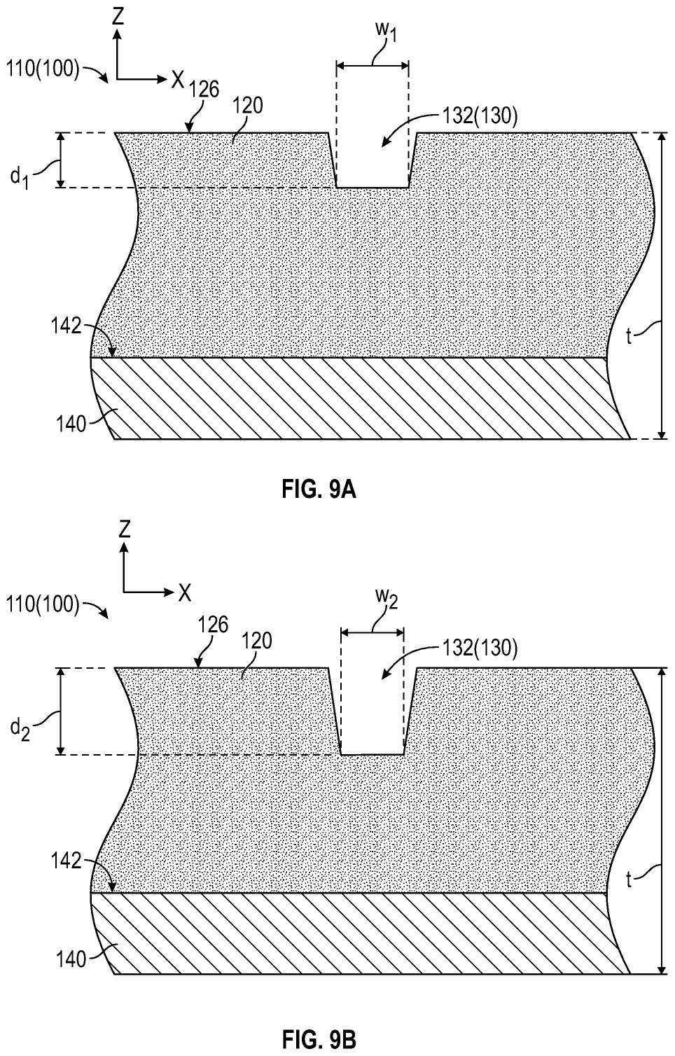

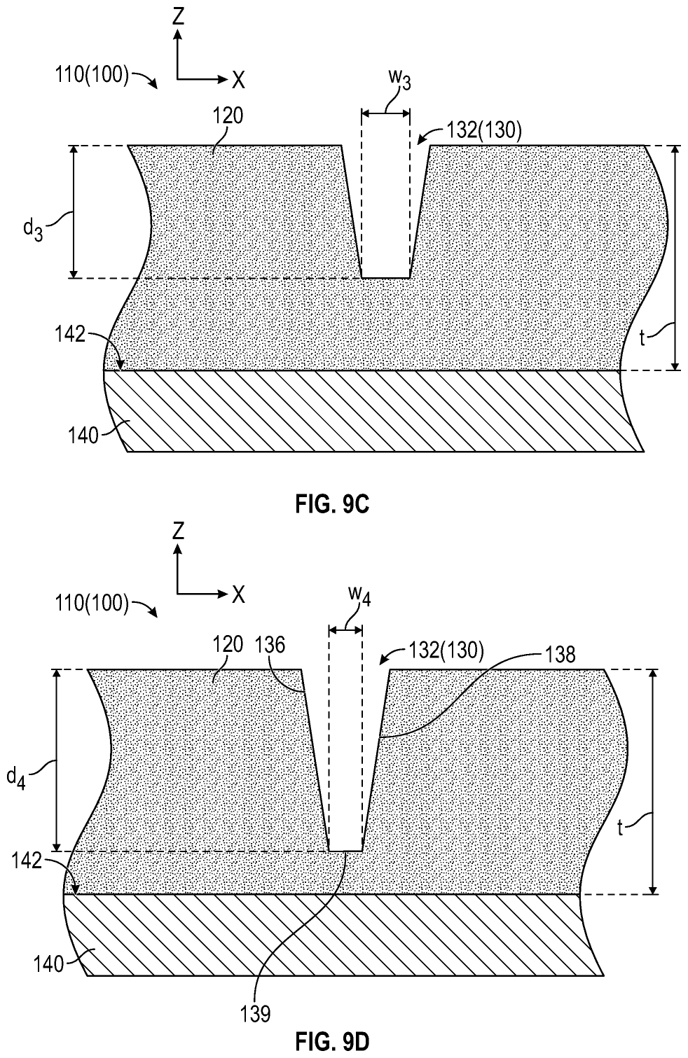

The slot 130 includes a first sidewall 136 and a second sidewall 138. Using the method discussed below to form the slots 130 on the curvilinear portion 114 of the flange 110 (substrate 140), the first sidewall 136 and the second sidewall 138 can be angled relative to each other to form an included angle α between the first sidewall 136 and the second sidewall 138. Accordingly, the slot 130, particularly, the radial slots 132, formed in the ceramic coating 120 on the curvilinear portion 114 have a V-shape. Although the slot 130 is shown in FIG. 6 as coming to a point, the V-shape is not so limited and the first sidewall 136 and the second sidewall 138 may be spaced apart from each other with a bottom surface 139 therebetween as shown in FIG. 9D.

The slot 130 preferably has a width w at an exterior surface 126 of the ceramic coating 120. To provide environmental durability and to avoid the CMAS issues discussed above, the width of the slot 130 may be designed to be sufficiently large to maintain desirably low capillary forces and to reduce risk of bridging of the slots with molten material, but small enough to not substantially affect the performance of the ceramic coating 120. For example, the slots 130 may be from ten microns to two hundred microns wide, such as from ten microns to one hundred microns wide, from fifteen microns to ninety microns wide, or from twenty microns to eighty microns wide. Because removing the ceramic coating 120 to form the slot 130 degrades the protective benefits of the ceramic coating 120, the V-shape may be used to minimize the amount of ceramic coating 120 removed and to provide a slot 130 that still improves the environmental and thermal durability of the coatings. Preferably, the included angle α is less than thirty degrees and more preferably less than fifteen degrees.

As discussed above, to form the slots 130 discussed herein, particularly, the slots 130 formed in the ceramic coating 120 on the curvilinear portion 114 of the flange 110, a laser ablation process may be used. Using a laser to remove ceramic of the ceramic coating 120 allows the slots 130 to be formed in the patterns, depths, and widths discussed above. Because the slot 130 does not extend through the thickness t of the ceramic coating 120, the laser ablation process is carefully controlled to avoid removing too much of the ceramic coating 120. Forming the slots 130 on the curvilinear portion 114 may be particularly challenging, requiring careful control in 3D space, as the distance from the laser changes as the laser is scanned in a scanning direction.

FIG. 7 shows a laser system 200 that may be used to form the slots 130 on the curvilinear portion 114 of the flange 110. The laser system 200 of this embodiment includes a laser scanner 210 that emits (radiates) a laser beam 212 towards the component (aft heat shield) 100. Any suitable laser scanner 210 may be used including, for example a laser beam scanning device using galvanometer mirrors. The laser scanner 210 may be a 3D laser scanner 210 where the laser beam 212 can be moved in scanning directions in the X-Y plane, and the laser beam 212 elevated in the Z-direction to change the focus depth of the laser beam 212.

The part to have slots formed therein may be referred to as a workpiece and, in this embodiment, is the aft heat shield 100. The laser system 200 includes a workbench 220 to hold and to position the aft heat shield 100 (workpiece) and the aft heat shield 100 is mounted on the workbench 220. The workbench 220 of this embodiment includes a pivotable base 222 that can be inclined relative to the X-Y plane of the laser system 200. The pivotable base 222 is shown as a plate in this embodiment and may be set at a fixed inclination angle relative to the X-Y plane. In this embodiment, the aft heat shield 100 is mounted to the workbench 220 such that, when the pivotable base 222 is not inclined, the axial direction A of the aft heat shield 100 is in the Z-direction of the laser system 200, and when inclined, the axial direction A of the aft heat shield 100 is angled relative to the Z-direction. The laser scanner 210 emits the laser beam 212 downward in the Z-direction in this embodiment and, when the pivotable base 222 is inclined, the axial direction A of the aft heat shield 100 is also inclined relative to the laser beam 212.

The workbench 220 further includes a rotatable base 224 and the aft heat shield 100 is mounted to the rotatable base 224 to be rotated about the longitudinal centerline 101, and, thus, the aft heat shield 100 can be rotated in the circumferential direction C. In this embodiment, a motor 226 is used to rotate the rotatable base 224 and to incline the pivotable base 222.

The laser system 200 also includes a plurality of image capture devices. In this embodiment, the image capture devices are cameras that sense visual light to create still images or video images. The plurality of image capture devices includes a first camera 232 and a second camera 234. The first camera 232 and the second camera 234 are positioned to capture different fields of view of the aft heat shield 100. The first camera 232 and the second camera 234 may be positioned substantially orthogonal to each other, such that the first camera 232 has a field of view generally of the X-Z plane and the second camera 234 has a field of view generally of the Y-Z plane. As used herein, “substantially orthogonally” may mean within plus or minus two and a half degrees of orthogonal and, more preferably, within plus or minus one degree of orthogonal. The first camera 232 may have a centerline 236 of the field of view of the first camera 232, and the second camera 234 may have a centerline 238 of the field of view of the second camera 234. The centerline 236 of the first camera 232 and the centerline 238 of the second camera 234 may be used to determine the positioning of the first camera 232 and the second camera 234 discussed above. The first camera 232 and the second camera 234 are used to position and to control the laser beam 212 as discussed below, and thus the field of view of the first camera 232 and the second camera 234 preferably includes the laser beam 212 and the aft heat shield 100 when positioned to form the slots 130.

The laser system 200 may also include a controller 240. The controller 240 is configured to operate various aspects of the laser system 200, including, in some embodiments, the laser scanner 210, the workbench 220, the first camera 232, and the second camera 234, discussed herein. The controller 240 is shown in FIG. 7 as being communicatively and operatively coupled to the laser scanner 210 such that the controller 240 can control the laser beam 212 in the manner discussed below. The controller 240 is also communicatively and operatively coupled to the workbench 220 and, more specifically, the motor 226 to move the aft heat shield 100. The controller 240 is further communicatively and operatively coupled to the first camera 232 and the second camera 234 to control the first camera 232 and the second camera 234 and to receive images (inputs) from the first camera 232 and the second camera 234.

In this embodiment, the controller 240 is a computing device having one or more processors 242 and one or more memories 244. The processor 242 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 244 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 244 can store information accessible by the processor 242, including computer-readable instructions that can be executed by the processor 242. The instructions can be any set of instructions or a sequence of instructions that, when executed by the processor 242, causes the processor 242 and the controller 240 to perform operations. In some embodiments, the instructions can be executed by the processor 242 to cause the processor 242 to complete any of the operations and functions for which the controller 240 is configured, as will be described further below. The instructions can be software written in any suitable programming language, or can be implemented in hardware. Additionally, and/or alternatively, the instructions can be executed in logically and/or virtually separate threads on the processor 242. The memory 244 can further store data that can be accessed by the processor 242.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

In the following discussion, the controller 240 will be described as executing various steps in the method of forming the slots 130. Any suitable means may, however, be used to execute this process and the means is not limited to the controller 240 and laser system 200 discussed above. When the controller 240 performs the steps below, the controller 240 may do so with or without user input. The controller 240 may be communicatively coupled to one or more user interfaces 246. Through the user interface 246, the controller 240 obtains input from and transmits output to an operator or a user. The operator or the user may, thus, also control the laser system 200 and, more specifically, the controller 240 through the user interfaces 246. Any suitable user interface 246 may be used including displays. The controller 240 may be communicatively coupled to the display to present information to the user, such as the images from the first camera 232 and the second camera 234. Other suitable user interfaces 246 includes a keyboard, a mouse, static buttons, or virtual button displayed on the display screen.

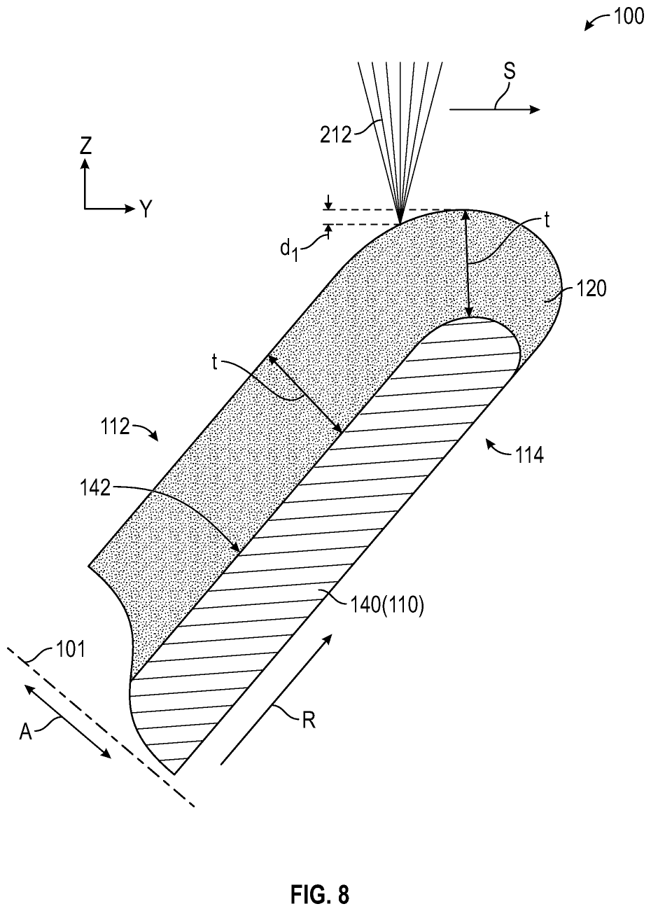

FIG. 8 is a cross-sectional view of the component (aft heat shield) 100 and, more specifically, the flange 110, taken along line 8-8 in FIG. 2, at a step prior to the formation of the slots 130. FIGS. 9A to 9D are cross-sectional views similar to FIG. 6 taken at different times as the radial slot 132 is being formed. FIG. 8 and FIGS. 9A to 9D will be used to illustrate a process of forming the slots 130 in the curvilinear portion 114 of the flange 110. FIG. 8 is a portion of the of the flange 110 taken before a first laser ablation pass. FIG. 9A is a portion of the flange 110 taken after a first laser ablation pass. FIG. 9B is the portion of the flange 110 shown in FIG. 9A taken after a second laser ablation pass. FIG. 9C is the portion of the flange 110 shown in FIG. 9A taken after a third laser ablation pass. FIG. 9D is the portion of the flange 110 shown in FIG. 9A taken after a fourth laser ablation pass.

The method of forming the slots 130 in the ceramic coating 120 on the curvilinear portion 114 of the substrate 140 will be described using one of the radial slots 132. This method, however, applies to any slot 130 formed in the ceramic coating 120 on the curvilinear portion 114 including the circumferential slots 134. The method includes performing a plurality of laser ablation passes. Four passes will be described herein, but any suitable number of passes may be used.

FIG. 8 illustrates a condition prior to the first laser ablation pass. In FIG. 8, the aft heat shield 100 has been positioned as described above with reference to FIG. 7 with the longitudinal centerline 101 of the aft heat shield 100 angled relative to the laser beam 212 and the Z-direction. The radial slot 132 (FIGS. 9A to 9D) is formed by making a plurality of laser ablation passes with the laser beam 212 to remove ceramic material from the ceramic coating 120 in each pass. The controller 240 focuses the laser beam 212 to a focus depth, which, in FIG. 8, is shown as d₁. As can be seen in FIG. 8, the aft heat shield 100 is positioned such that the curvilinear portion 114 is curved in the scanning direction S and also in the thickness direction t of the ceramic coating 120. The scanning direction S in this embodiment is transverse to the thickness direction t of the ceramic coating 120. In forming the radial slot 132 the scanning direction S is also the radial direction R of the aft heat shield 100.

The controller 240 then scans the laser beam 212 in the scanning direction S while irradiating the ceramic coating 120 formed on the curvilinear portion 114 of the substrate 140 (aft heat shield 100). The focus depth is set such that the focus depth does not exceed the maximum desired depth of the radial slot 132 in the ceramic coating 120 at any location along the scanning distance. The scanning distance is the distance over which the laser beam 212 is translated while irradiating the ceramic coating 120. The focus depth is constant (does not change) over the scanning distance.

FIG. 9A shows a portion of the flange 110 taken after the first laser ablation pass. The radial slot 132 has been formed with a depth of d₁. As discussed above, the radial slot 132 is preferably formed to have a V-shape with a first sidewall 136 and a second sidewall 138 that are angled relative to each other. Accordingly, the controller 240 controls the width of the laser beam 212 to produce a width w₁ of the radial slot 132 for the first pass.

The controller 240 then repeats the steps above for each subsequent pass. The focus depth of each subsequent pass is deeper in the thickness direction t of the ceramic coating 120 than the pass preceding the subsequent pass. The controller 240 also controls the beam width of the laser beam 212 to produce a width of the radial slot 132 for each subsequent pass that is less than the width of the radial slot 132 of the pass preceding the subsequent pass. For example, FIG. 9B is the portion of the flange 110 shown in FIG. 9A taken after the second laser ablation pass. As shown in FIG. 9B, the depth d₂ of the radial slot 132 after the second pass is deeper in the thickness direction than the depth d₁ of the radial slot 132 after the first pass, and the width w₂ of the radial slot 132 after the second pass is less than the width w₁ of the radial slot 132 after the first pass. As shown in FIG. 9C, the depth d₃ of the radial slot 132 after the third pass is deeper in the thickness direction than the depth d₂ of the radial slot 132 after the second pass, and the width w₃ of the radial slot 132 after the third pass is less than the width w₂ of the radial slot 132 after the second pass. As shown in FIG. 9D, the depth d₄ of the radial slot 132 after the fourth pass is deeper in the thickness direction than the depth d₃ of the radial slot 132 after the third pass, and the width w₄ of the radial slot 132 after the fourth pass is less than the width w₃ of the radial slot 132 after the third pass. As noted above, the radial slot 132 shown in FIG. 9D includes a bottom surface 139 and the first sidewall 136 is spaced apart from the second sidewall 138 at the bottom surface 139 by the width w₄.

As noted above, the focus depth is set for each pass such that the focus depth does not exceed the maximum desired depth of the radial slot 132 in the ceramic coating 120 at any location along the scanning distance. The controller 240 may control the start and the end position of the laser ablation pass, and, thus, the scanning distance, to control the depth of the radial slot 132 in this manner. Accordingly, the controller 240 may set a start position and/or an end position of each of the laser ablation passes. In some embodiments, the start position and/or the end position of at least one subsequent pass is different than the pass preceding the subsequent pass.

Each of the radial slots 132 in the curvilinear portion 114 shown in FIGS. 2 to 4 may be formed using the process discussed above. After the first radial slot 132 is formed, the controller 240 rotates the aft heat shield 100 about the longitudinal centerline 101 using, for example, the rotatable base 224 and the motor 226. Then, the controller 240 repeats the process above to form the second radial slot 132.

By using a plurality of passes the depth d 4 of each of the radial slots 132 can be controlled to have a depth that is less than the thickness t of the ceramic coating 120, as discussed above. Such an approach enables the slots to be formed on the curvilinear portion 114 whereas other laser ablation techniques are limited to the planar portion 112. To do so, controlling the focus of the laser beam 212 in 3D space (locating the focus of the laser beam 212 in the 3D coordinate system discussed above) is important and the following calibration process may be used to locate the focus of the laser beam 212.

In the calibration process, the laser system 200 is set up as described above with reference to FIG. 7, including positioning the first camera 232 and the second camera 234 as described above such that the field of view of the second camera 234 is transverse to the field of view of the first camera 232. The first camera 232 and the second camera 234 are positioned to be substantially orthogonal to each other and, as noted above, the field of view of the second camera 234 may be within five degrees of orthogonal of the field of view of the first camera 234 and, more preferably, within two degrees of orthogonal of the field of view of the first camera 234. Although these steps may be carried out by the controller 240 if the first camera 232 and the second camera 234 are each connected to an appropriate movement mechanism, such actions may be performed by a user of the laser system 200.

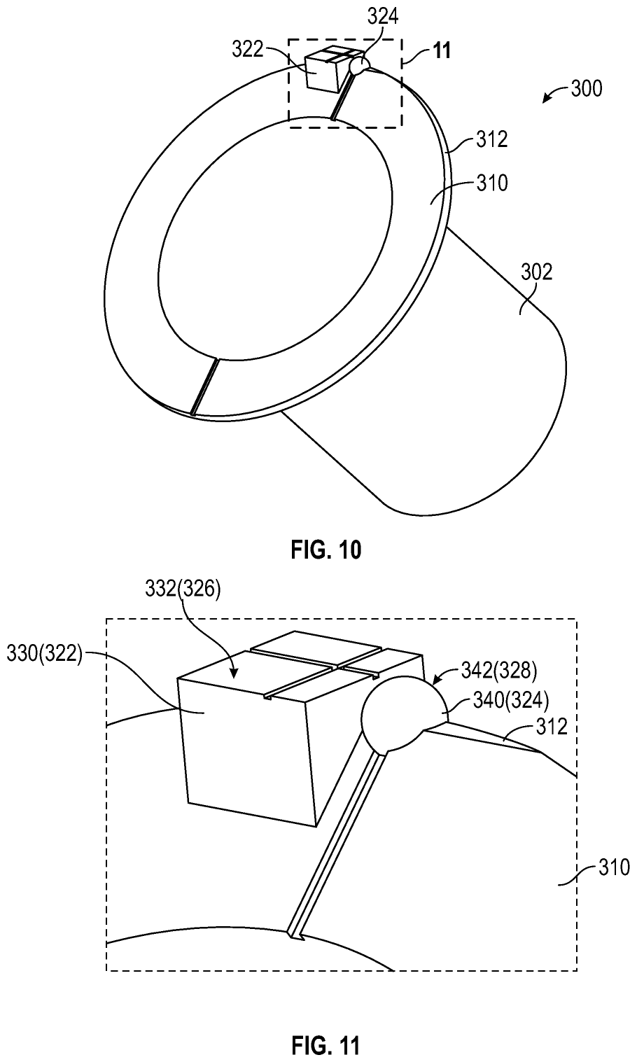

FIG. 10 shows a calibration assembly 300 that may be used with the calibration method discussed herein. The calibration assembly 300 is placed on the workbench 220 (see FIG. 7) in the manner described above for the workpiece (aft heat shield 100). The calibration assembly 300 preferably has a geometry that is similar to the workpiece and, thus, has a geometry similar to the aft heat shield 100 in this embodiment. The calibration assembly 300 includes a support part 302 having a flange 310 that is sized and shaped in a manner similar to the flange 110 of the aft heat shield 100. The flange 110 includes an outer edge 312 positioned where the curvilinear portion 114 of the flange 110 is located.

The calibration assembly 300 also includes a plurality of calibration blocks including a first calibration block 322 and a second calibration block 324. The first calibration block 322 and the second calibration block 324 are positioned on the support part 302 and, more specifically, the flange 310 of the support part 302. The first calibration block 322 and the second calibration block 324 may be placed, for example, on the outer edge 312 of the flange 310 of the support part 302. The first calibration block 322 and the second calibration block 324 are positioned adjacent to each other on the support part 302 and, more specifically, adjacent to each other in a circumferential direction on the outer edge 312 of the flange 310.

FIG. 11 is a detail view, showing detail 11 in FIG. 10, of the flange 310 of the calibration assembly 300. The first calibration block 322 includes a calibration surface 326, and the second calibration block 324 includes a calibration surface 328. In this embodiment, the first calibration block 322 is a planar calibration block 330 and the calibration surface 326 of the planar calibration block 330 (first calibration block 322) is a planar surface 332. Also, in this embodiment, the second calibration block 324 is a spherical calibration block 340 and the calibration surface 328 of the spherical calibration block 340 (second calibration block 324) is a spherically shaped surface 342. In this embodiment, the spherically shaped surface 342 has at least a part spherical shape and, in some embodiments, may be a hemisphere or more.

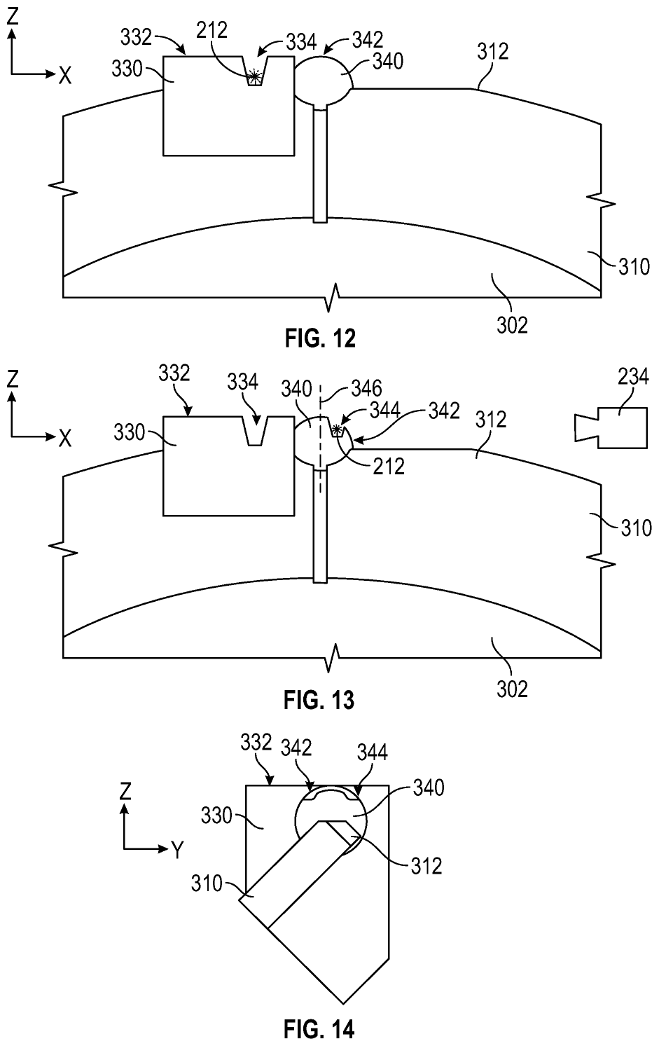

FIG. 12 shows a field of view of the first camera 232 during steps of the calibration method. The flange 310 of the support part 302, including the planar calibration block 330 and the spherical calibration block 340, is positioned within the field of view of the first camera 232 (FIG. 7). The calibration method includes forming a first calibration slot 334 in the planar calibration block 330 and, more specifically, in the planar surface 332. The controller 240 irradiates the planar calibration block 330 with the laser beam 212 (FIG. 7) while scanning the laser beam 212 in a first scanning direction. In this embodiment, the first scanning direction is transverse to the field of view of the first camera 232 (into and out of the page in the view shown in FIG. 12) and generally parallel to the centerline 236 (FIG. 7) of the field of view of the first camera 232. The first calibration slot 334 can be used to locate the focus of the laser beam 212 as a position in the field of view of the first camera 232, and the calibration method includes locating the position of the focus of the laser beam 212 (FIG. 7) in the field of view of the first camera 232 based on the depth of the first calibration slot 334.

FIG. 13 shows a field of view of the first camera 232 (FIG. 7) during steps subsequent to the steps of the calibration method illustrated in FIG. 12. After the steps discussed above, the controller 240 (FIG. 7) moves at least one of the laser beam 212 (FIG. 7) and the spherical calibration block 340 so that the spherical calibration block 340 is in a position to be irradiated by the laser beam 212. The calibration method also includes forming a second calibration slot 344 in the spherical calibration block 340 and, more specifically, in the spherically shaped surface 342 at a position to be viewed by the second camera 234. The controller 240 then irradiates the spherical calibration block 340 with the laser beam 212 while scanning the laser beam 212 in a second scanning direction. In this embodiment, the second scanning direction is the same direction as the first scanning direction—transverse to the field of view of the first camera 232 (into and out of the page in the view shown in FIG. 13) and generally parallel to centerline 236 (FIG. 7) of the field of view of the first camera 232.

As noted above, the controller 240 (FIG. 7) forms the second calibration slot 344 on the spherically shaped surface 342 in a position to be viewed by the second camera 234 (FIG. 7). In this embodiment, the spherical calibration block 340 includes a centerline 346 and the controller 240 (FIG. 7) forms the second calibration slot 344 on one side of the centerline 346. Preferably, the controller 240 forms the second calibration slot 344 on the side of the centerline 346 closest to the second camera 234 and away from the planar calibration block 330. The position of the second camera 234 is schematically depicted in FIG. 14 to illustrate the relationship described above, but the second camera 234 is not normally in the field of view of the first camera 232.

FIG. 14 shows a field of view of the second camera 234 during steps subsequent to the steps of the calibration method illustrated in FIG. 13. The planar calibration block 330 is positioned on one side of the spherical calibration block 340, and, in this embodiment, the planar calibration block 330 is positioned further away from the second camera 234 than the spherical calibration block 340 so that both the planar calibration block 330 and the spherical calibration block 340 are in the field of view of the second camera 234. With the second calibration slot 344 being formed on the spherically shaped surface 342 in the manner described above, the second calibration slot 344 is visible in the field of view of the second camera 234. The second calibration slot 344 can be used to locate the focus of the laser beam 212 (FIG. 7) at a position in the field of view of the second camera 234 (FIG. 7), and the calibration method includes locating the position of the focus of the laser beam 212 in the field of view of the second camera 234 based on the depth of the second calibration slot 344.

The second calibration slot 344 also can be used to locate the focus of the laser beam 212 (FIG. 7) as a position in the field of view of the first camera 232 (FIG. 7), and the calibration method may include locating the position of the focus of the laser beam 212 in the field of view of the first camera 232 based on the depth of the second calibration slot 344. For example, the planar calibration block 330 is useful in locating an initial position of the laser beam 212 and, thus, facilitates locating the laser beam 212 to form the second calibration slot 344 in a position that can be viewed by both the first camera 232 and the second camera 234 (FIG. 7), but, in some embodiments, the steps of forming the first calibration slot 334 and locating the focus of the laser beam 212 based on the first calibration slot 334 can be omitted. When the first calibration slot 334 is omitted, the calibration slot formed in the spherical calibration block 340 (the second calibration slot 344 discussed herein) can be used to locate the position of the focus of the laser beam 212 in the field of view of the first camera 232 based on the depth of the calibration slot formed in the spherical calibration block 340 (the second calibration slot 344).

Without strain relief, the ceramic coating 120 may be susceptible to strain failure and spallation, particularly, when the ceramic coating 120 is used in high temperature environments, such as a gas turbine engine. The components 100 discussed herein include non-planar surfaces and the plurality of slots 130 formed in the ceramic coating 120 can be formed on the non-planar surfaces in addition to the planar surfaces. The methods discussed herein enable these slots 130 to be formed by laser ablation on non-planer surfaces of the components 100 in addition to planer surfaces, thus, providing durability and resistance to spallation and other environmental conditions. The calibration method discussed herein enables the laser ablation process discussed above by ensuring an accurate location of the focus of the laser beam 212 in 3D space.

Further aspects of the present disclosure are provided by the subject matter of the following clauses.

A method of forming a slot in a coating formed on a curvilinear portion of a part comprises performing a plurality of laser ablation passes. Each laser ablation pass of the plurality of laser ablation passes includes focusing a laser beam to a focus depth, irradiating the coating of the curvilinear portion with the laser beam focused at the focus depth to remove coating material of the coating by laser ablation, and scanning the laser beam in a scanning direction while irradiating the coating of the curvilinear portion with the laser beam. The scanning direction is a direction transverse to a thickness direction of the coating, wherein the focus depth of each subsequent pass of the plurality of laser ablation passes is deeper in a thickness direction of the coating than the pass preceding the subsequent pass.

The method of the preceding clause, wherein the curvilinear portion of the part is curved in the scanning direction.

The method of any preceding clause, wherein irradiating the coating produces a width of the slot for each pass, and irradiating the coating includes controlling the laser beam to produce a width of the slot for each subsequent pass that is less than the width of the slot of the pass preceding the subsequent pass.

The method of any preceding clause, wherein the number of the plurality of laser ablation passes is controlled to produce a slot that has a depth that is less than the thickness of the coating.

A method of forming a slot in a coating formed on a curvilinear portion of a part, the curvilinear portion of the part being curved in a direction transverse to a longitudinal axis of the part and in a direction parallel to the longitudinal axis of the part, comprises forming a first slot using the method of any preceding clause, the scanning direction having a component direction parallel to the longitudinal axis, rotating the part about the longitudinal axis, and forming a second slot using the method of any preceding clause, the scanning direction having a component direction parallel to the longitudinal axis.

The method of any preceding clause, wherein forming the first slot and forming the second slot each includes scanning the laser beam in the scanning direction with a component direction of the scanning direction being in a radial direction of the part.

The method of any preceding clause, wherein the laser beam is scanned in the scanning direction while irradiating the coating of the curvilinear portion with the laser beam for a scanning distance, the focus depth being constant over the scanning distance.

The method of any preceding clause, wherein the scanning distance includes a start position and an end position, at least one of the start position and the end position of a subsequent pass being different than the pass preceding the subsequent pass.

The method of any preceding clause, wherein the coating is a ceramic coating.

The method of any preceding clause, wherein the ceramic coating is formed on a substrate of the part, the substrate being a metal.

The method of any preceding clause, wherein the part is a component of a gas turbine engine and the ceramic coating is a thermal barrier coating.

The method of any preceding clause, wherein the part is a heat shield for a fuel nozzle.

The method of any preceding clause, wherein the heat shield includes a flange, the flange including the curvilinear portion.

The method of any preceding clause, further comprising calibrating a laser beam prior to performing the plurality of laser ablation passes, wherein calibrating the laser beam includes, imaging a calibration block with a first camera, the first camera having a field of view and the calibration block having a calibration surface, forming a calibration slot in the calibration surface of the calibration block by irradiating the calibration block with the laser beam while scanning the laser beam in a scanning direction, the scanning direction being transverse to the field of view of the first camera, locating the position of the focus of the laser beam in the field of view of the first camera based on the depth of the calibration slot, and locating the position of the focus of the laser beam in a field of view of a second camera based on the depth of the calibration slot, the field of view of the second camera being transverse to the field of view of the first camera.

The method of any preceding clause, wherein the field of view of the second camera is within two degrees of orthogonal of the field of view of the first camera.

The method of any preceding clause, wherein the calibration block is a spherical calibration block and the calibration surface of the spherical calibration block is a spherically shaped surface.

The method of any preceding clause, wherein the spherical calibration block includes a centerline, the calibration slot being formed on the side of the centerline closest to the second camera.

The method of any preceding clause, wherein the calibration block is a second calibration block, the calibration surface is a second calibration surface, the calibration slot is a second calibration slot and the scanning direction is a second scanning direction, and wherein, prior to forming the second calibration slot, calibrating the laser beam further includes imaging a first calibration block with the first camera, the first calibration block having a calibration surface, forming a first calibration slot in the calibration surface of the first calibration block by irradiating the calibration surface of the first calibration block with the laser while scanning the laser in a first scanning direction, the first scanning direction being transverse to the field of view of the first camera, locating the position of the focus of the laser beam in the field of view of the first camera based on the depth of the first calibration slot.

The method of any preceding clause, wherein the first calibration block and the second calibration block are positioned on a support part.

The method of any preceding clause, wherein the first calibration block and the second calibration block are positioned adjacent to each other on the support part.

The method of any preceding clause, wherein the second calibration block is a spherical calibration block and the second calibration surface of the spherical calibration block is a spherically shaped surface.

The method of any preceding clause, wherein the first calibration block is a planar calibration block and the calibration surface of the planar calibration block is a planar surface.

The method of any preceding clause, wherein the spherical calibration block includes a centerline, the calibration slot being formed on the side of the centerline closest to the second camera and away from the first calibration block.

A method of calibrating a laser beam comprises imaging a calibration block with a first camera, the first camera having a field of view and the calibration block having a calibration surface, forming a calibration slot in the calibration surface of the calibration block by irradiating the calibration block with the laser beam while scanning the laser beam in a scanning direction, the scanning direction being transverse to the field of view of the first camera, locating the position of the focus of the laser beam in the field of view of the first camera based on the depth of the calibration slot, and locating the position of the focus of the laser beam in a field of view of a second camera based on the depth of the calibration slot, the field of view of the second camera being transverse to the field of view of the first camera.

The method of the preceding clause, wherein the field of view of the second camera is within two degrees of orthogonal of the field of view of the first camera.

The method of any preceding clause, wherein the calibration block is a second calibration block, the calibration surface is a second calibration surface, the calibration slot is a second calibration slot and the scanning direction is a second scanning direction, and wherein, prior to forming the second calibration slot, the method further includes imaging a first calibration block with the first camera, the first calibration block having a calibration surface, forming a first calibration slot in the calibration surface of the first calibration block by irradiating the calibration surface of the first calibration block with the laser while scanning the laser in a first scanning direction, the first scanning direction being transverse to the field of view of the first camera, and locating the position of the focus of the laser beam in the field of view of the first camera based on the depth of the first calibration slot.

The method of any preceding clause, wherein the first calibration block and the second calibration block are positioned on a support part.

The method of any preceding clause, wherein the first calibration block and the second calibration block are positioned adjacent to each other on the support part.

The method of any preceding clause, wherein the calibration block is a spherical calibration block and the calibration surface of the spherical calibration block is a spherically shaped surface.

The method of any preceding clause, wherein the spherical calibration block includes a centerline, the calibration slot being formed on the side of the centerline closest to the second camera.

The method of any preceding clause, wherein the second calibration block is a spherical calibration block and the second calibration surface of the spherical calibration block is a spherically shaped surface.

The method of any preceding clause, wherein the first calibration block is a planar calibration block and the calibration surface of the planar calibration block is a planar surface.

The method of any preceding clause, wherein the spherical calibration block includes a centerline, the calibration slot being formed on a side of the centerline closest to the second camera and away from the first calibration block.

A ceramic coated part for a gas turbine engine comprises a substrate having a surface, a ceramic coating deposited on the surface, and a plurality of slots formed in the portion of the ceramic coating on the curvilinear portion of the surface. At least a portion of the surface is a curvilinear portion of the surface. The curvilinear portion of the surface has a direction of curvature. The ceramic coating deposited on the surface includes the curvilinear portion of the surface. The ceramic coating has an exterior surface and a thickness. Each slot of the plurality of slots has a width at the exterior surface of the ceramic coating from ten microns to two hundred microns wide. Each slot of the plurality of slots has a depth that is less than the thickness of the ceramic coating.

The ceramic coated part of the preceding clause, wherein the part includes a longitudinal axis and a circumferential direction about the longitudinal axis, each slot of the plurality of slots being circumferential slots formed in the circumferential direction of the part.

The ceramic coated part of any preceding clause, wherein each slot of the plurality of slots has a V-shape.

The ceramic coated part of any preceding clause, wherein each slot of the plurality of slots includes a first sidewall, a second sidewall, and a bottom surface, the first sidewall and the second sidewall being spaced apart from each other with the bottom surface therebetween.

The ceramic coated part of any preceding clause, wherein the part includes a longitudinal axis and a radial direction from the longitudinal axis, each slot of the plurality of slots being radial slots formed in the radial direction of the part.

The ceramic coated part of any preceding clause, wherein the part is a heat shield for a fuel nozzle.

The ceramic coated part of any preceding clause, wherein the heat shield includes a flange, the flange being the substrate.

Although the foregoing description is directed to the preferred embodiments, other variations and modifications will be apparent to those skilled in the art, and may be made without departing from the spirit or the scope of the disclosure. Moreover, features described in connection with one embodiment may be used in conjunction with other embodiments, even if not explicitly stated above.

1. A method of forming a slot in a coating formed on a curvilinear portion of a part, the method comprising performing a plurality of laser ablation passes, each laser ablation pass of the plurality of laser ablation passes including:
focusing a laser beam to a focus depth;
irradiating the coating of the curvilinear portion with the laser beam focused at the focus depth to remove coating material of the coating by laser ablation; and
scanning the laser beam in a scanning direction while irradiating the coating of the curvilinear portion with the laser beam, the scanning direction being a direction transverse to a thickness direction of the coating,
wherein the focus depth of each subsequent pass of the plurality of laser ablation passes is deeper in a thickness direction of the coating than the pass preceding the subsequent pass.

2. The method of claim 1, wherein the curvilinear portion of the part is curved in the scanning direction.

3. The method of claim 1, wherein irradiating the coating produces a width of the slot for each pass, and irradiating the coating includes controlling the laser beam to produce a width of the slot for each subsequent pass that is less than the width of the slot of the pass preceding the subsequent pass.

4. The method of claim 1, wherein the number of the plurality of laser ablation passes is controlled to produce a slot that has a depth that is less than the thickness of the coating.

5. A method of forming a slot in a coating formed on a curvilinear portion of a part, the curvilinear portion of the part being curved in a direction transverse to a longitudinal axis of the part and in a direction parallel to the longitudinal axis of the part, the method comprising:
forming a first slot using the method of claim 1, the scanning direction having a component direction parallel to the longitudinal axis;
rotating the part about the longitudinal axis; and
forming a second slot using the method of claim 1, the scanning direction having a component direction parallel to the longitudinal axis.

6. The method of claim 5, wherein forming the first slot and forming the second slot each includes scanning the laser beam in the scanning direction with a component direction of the scanning direction being in a radial direction of the part.

7. The method of claim 1, wherein the laser beam is scanned in the scanning direction while irradiating the coating of the curvilinear portion with the laser beam for a scanning distance, the focus depth being constant over the scanning distance.

8. The method of claim 7, wherein the scanning distance includes a start position and an end position, at least one of the start position and the end position of a subsequent pass being different than the pass preceding the subsequent pass.

9. The method of claim 1, wherein the coating is a ceramic coating, and the ceramic coating is formed on a substrate of the part, the substrate being a metal.

10. The method of claim 9, wherein the part is a component of a gas turbine engine and the ceramic coating is a thermal barrier coating.

11. The method of claim 10, wherein the part is a heat shield for a fuel nozzle, the heat shield including a flange having the curvilinear portion.

12. The method of claim 1, further comprising calibrating a laser beam prior to performing the plurality of laser ablation passes, wherein calibrating the laser beam includes:
imaging a calibration block with a first camera, the first camera having a field of view and the calibration block having a calibration surface;
forming a calibration slot in the calibration surface of the calibration block by irradiating the calibration block with the laser beam while scanning the laser beam in a scanning direction, the scanning direction being transverse to the field of view of the first camera;
locating the position of the focus of the laser beam in the field of view of the first camera based on the depth of the calibration slot; and
locating the position of the focus of the laser beam in a field of view of a second camera based on the depth of the calibration slot, the field of view of the second camera being transverse to the field of view of the first camera.

13. The method of claim 12, wherein the field of view of the second camera is within two degrees of orthogonal of the field of view of the first camera.

14. The method of claim 12, wherein the calibration block is a spherical calibration block and the calibration surface of the spherical calibration block is a spherically shaped surface.

15. The method of claim 14, wherein the spherical calibration block includes a centerline, the calibration slot being formed on the side of the centerline closest to the second camera.

16. The method of claim 12, wherein the calibration block is a second calibration block, the calibration surface is a second calibration surface, the calibration slot is a second calibration slot and the scanning direction is a second scanning direction, and
wherein, prior to forming the second calibration slot, calibrating the laser beam further includes:
imaging a first calibration block with the first camera, the first calibration block having a calibration surface;
forming a first calibration slot in the calibration surface of the first calibration block by irradiating the calibration surface of the first calibration block with the laser while scanning the laser in a first scanning direction, the first scanning direction being transverse to the field of view of the first camera; and
locating the position of the focus of the laser beam in the field of view of the first camera based on the depth of the first calibration slot.

17. The method of claim 16, wherein the first calibration block and the second calibration block are positioned on a support part.

18. The method of claim 16, wherein the second calibration block is a spherical calibration block and the second calibration surface of the spherical calibration block is a spherically shaped surface.

19. The method of claim 18, wherein the first calibration block is a planar calibration block and the calibration surface of the planar calibration block is a planar surface.

20. The method of claim 18, wherein the spherical calibration block includes a centerline, the calibration slot being formed on the side of the centerline closest to the second camera and away from the first calibration block.
